(19) United States
(12) Patent Application Publication
(10) Pub. No.: US 2025/0288127 A1
(43) Pub. Date: Sep. 18, 2025

(54) HOUSING AND MOUNTING ASSEMBLY FOR PROTECTIVE DISPLAY CASES

(71) Applicant: M1NT Inc., Wilmington, DE (US)

(72) Inventors: Collin M. Newman, Huntington Beach, CA (US); Brian Pirrip Bybee, Huntington Beach, CA (US); Shannon J. Soong, Fayetteville, GA (US); Samuel J. Norcutt, Huntington Beach, CA (US); Jonathan E. Thai, San Jose, CA (US); Michael S. Yim, San Jose, CA (US)

(21) Appl. No.: 19/082,716

(22) Filed: Mar. 18, 2025

Related U.S. Application Data
(60) Provisional application No. 63/566,632, filed on Mar. 18, 2024.

(51) Int. Cl. A47F 3/00; E05B 47/00

(52) U.S. Cl. CPC A47F 3/002; A47F 3/001; E05B 47/0002

(57) ABSTRACT

A housing assembly for a protective display case may include a display case cutout configured to removably receive a protective display case, with an electromagnetic assembly providing magnetic attraction to secure the display case. The assembly incorporates case lighting, biometric scanning access controls, and an electronic reader (e.g., RFID, NFC, etc.) to store and display ownership, grading and provenance information. A screen positioned adjacent to each display case cutout shows item details including production year, brand, grade, and authentication data. The housing assembly may be arranged in single or multiple rows, with protective display cases organized horizontally or vertically. A mobile application interface may enable remote control of lighting settings, data visibility, screen brightness, and electromagnetic locking mechanisms. The system may combine physical security features with enhanced visual presentation capabilities to protect valuable collectibles while maintaining secure tracking of ownership and authentication.

### CROSS-REFERENCE TO RELATED APPLICATIONS

This application claims the benefit of U.S. Provisional Application No. 63/566,632 filed on Mar. 18, 2024. The entire disclosure of the above application is incorporated herein by reference.

### FIELD

The present technology relates to mounting assemblies for displaying and protecting collectibles and artwork, and, more particularly, to housing mounting assemblies that combine with protective display cases to prevent damage, enhance security features, deter counterfeiting, and provide enhanced visual presentation of collectible items such as trading cards.

### INTRODUCTION

This section provides background information related to the present disclosure which is not necessarily prior art.

Options for displaying, protecting and long-term preservation of one or more pieces of art and/or collectibles, such as trading cards, memorabilia, and other similar artwork are typically limited to low quality transparent cases. These display solutions, however, fail to adequately address several critical concerns faced by collectors and art enthusiasts. For example, such display cases typically offer only basic physical protection from handling and environmental factors, leaving valuable items vulnerable to tampering, theft, and counterfeiting. A lack of security measures may mean that once a case is compromised, the authenticity and provenance of the contained item may become questionable, potentially affecting its value and marketability. Visual presentation capabilities of certain transparent cases and other display solutions may also be rudimentary, failing to enhance or properly showcase the artistic and aesthetic qualities of valuable collectibles. Such transparent cases also may generally lack proper lighting features and display elements that may enhance the viewing experience and highlight the unique characteristics of each piece. Certain transparent cases and other display systems may also have limited or no means for verifying the authenticity of a displayed item or allow for maintaining a secure record of ownership history, grading information, and other details that contribute to the value of the displayed item. The inability to incorporate advanced features such as biometric access control, electromagnetic locking mechanisms, or digital authentication systems may further leave valuable collections vulnerable to unauthorized access and manipulation.

It would therefore be desirable to have a housing system that may effectively protect a collectible while enhancing presentation of the item. Such a system should combine robust physical security features, advanced authentication capabilities, and enhanced visual presentation elements to comprehensively address issues faced with the display of a collectable item, while deterring counterfeiting and providing verifiable proof of authenticity and ownership. It would be further advantageous to display a collectible item in a mounting assembly that could be combined with protective a display case that securely stores the item without damaging it and while simultaneously reducing the chances of counterfeiting and/or theft.

Accordingly, there is a continuing need for a housing assembly that combines an enhanced locking mechanism, access controls, and enhanced visual presentation features while providing an authentication capability.

### SUMMARY

In concordance with the instant disclosure, a housing assembly that combines an enhanced locking mechanism, access controls, and enhanced visual presentation features while providing an authentication capability has been surprisingly discovered.

The present technology includes articles of manufacture, systems, and processes that relate to a housing assembly for a protective display case configured to securely store and display a collectible while preventing damage and deter counterfeiting. The housing and assembly may incorporate electromagnetic assemblies, biometric scanning devices, and case lighting systems to provide enhanced security features and visual presentation capabilities. The mounting assemblies further integrate electronic readers, screens, and mobile application interfaces to enable authentication, display item details, and provide remote control of lighting and security settings.

In certain embodiments, a housing assembly for a protective display case is provided. The housing assembly for a protective display case may include a display case cutout formed in a surface of the housing assembly, an electromagnetic assembly within the housing assembly adjacent the display case cutout, and a case light. The display case cutout may be configured for removably receiving the protective display case. The electromagnetic assembly may be configured to secure the display case within the display case cutout. The case light may be configured to illuminate a portion of the display case cutout.

In certain embodiments, a method of using a housing assembly for protecting and displaying art and collectibles is provided that may include providing a protective display case containing art or a collectible. The method may also include inserting the protective display case into a display case cutout of the housing assembly, and activating an electromagnetic assembly to secure the protective display case within the display case cutout. The protective display case may be illuminated in the protective display case in the display case cutout. Ba

In certain embodiments, a housing system for a protective display case is provided that may include a plurality of display case cutouts, an electromagnetic assembly, and a case light. The display case cutout may be configured for removably receiving the protective display case. The electromagnetic assembly may be configured to secure the display case within the display case cutout. The case light may be configured to illuminate a portion of the display case cutout and the control device may be configured to enable control of the electromagnetic assembly. A screen may be positioned beneath a display case cutout. A scanning device may be configured to enable control of the electromagnetic assembly. The housing system may further include a plurality of screens, where each screen may be positioned beneath a display case cutout and a plurality of electronic code readers. Each reader may be in a display space cutout and configured to read information from the protective display case in order to retrieve unique details about an item contained within the protective display case and display the details on the screen. A mobile device may be in remote communication with the housing system. The mobile device may be configured to control lighting settings, data visibility on the screen, screen brightness, and locking and unlocking of the electromagnetic assemblies of the housing system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram depicting aspects of a housing assembly configured for removably receiving a protective display case, according to an embodiment of the present disclosure.

FIG. 2A is a front elevational view of a portion of a housing configured for removably receiving the protective display case of a collectible, according to an embodiment of the present disclosure.

FIG. 2B is a front perspective view of the portion of the housing removably receiving the protective display case for the collectible, according to an embodiment of the present disclosure.

FIG. 2C is a front elevational view of the housing configured for removably receiving the protective display case in remote communication with a mobile device, according to an embodiment of the present disclosure.

FIG. 3 is a right-side perspective view of housing removably receiving a plurality of protective display cases arranged in a row, according to an embodiment of the present disclosure.

FIG. 4 is a right-side perspective view of the housing configured for removably receiving the plurality of protective display cases arranged in a row, according to an embodiment of the present disclosure.

FIG. 5 is a right-side exploded perspective view of the housing configured for removably receiving the plurality of protective display cases arranged in a row, according to an embodiment of the present disclosure.

FIG. 6 is a front elevational view of a housing configured for removably receiving the plurality of protective display cases, according to an embodiment of the present disclosure.

FIG. 7A is a front elevational view of a single or plurality of housing configured for removably receiving a plurality of protective display cases arranged in a plurality of rows and columns, according to an embodiment of the present disclosure.

FIG. 7B is a front elevational view of a single or plurality of housing configured for removably receiving a plurality of protective display cases arranged in a plurality of rows and columns, as displayed within a living environment, according to an embodiment of the present disclosure.

FIG. 8 is a method of using a housing assembly for protecting and displaying art and collectibles, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps may be different in various embodiments, including where certain steps may be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that can be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it can be directly on, engaged, connected or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

The present technology relates to a housing and mounting assembly for protective display cases that may include an electromagnetic locking mechanism, a biometric access control, and enhanced visual presentation features to securely store and display a collectible item. The mounting assembly may incorporate an electronic reader and a screen to enable authentication and display of one or more details of the item. The mounting assembly may include remote control of one or more lighting and security settings through a mobile application interface to prevent damage, enhance security, deter counterfeiting, and provide enhanced visual presentation of the item or collectible, such as a trading card.

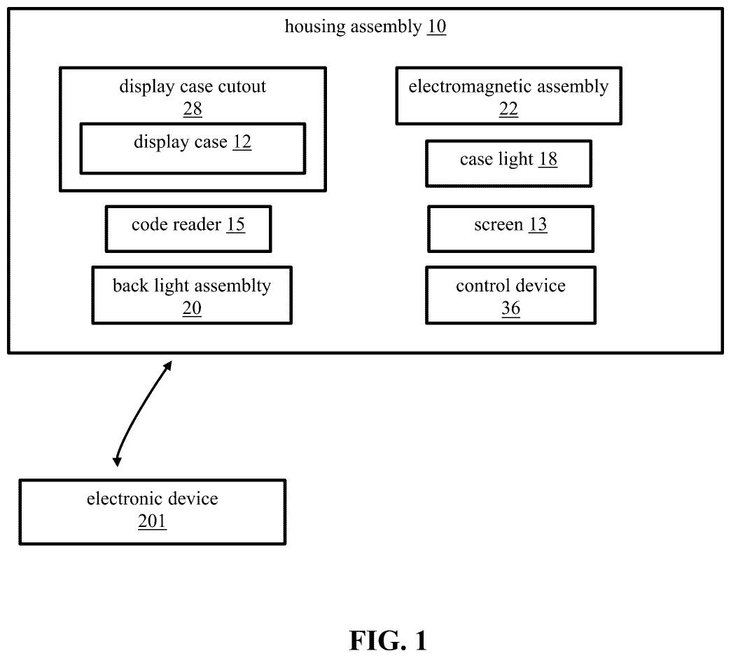

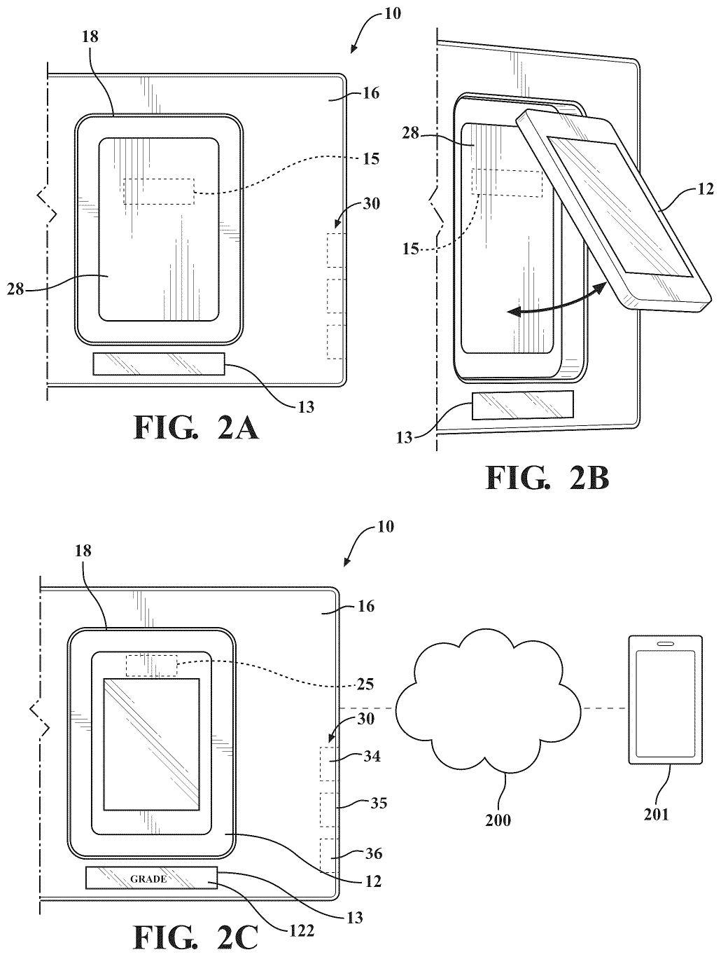

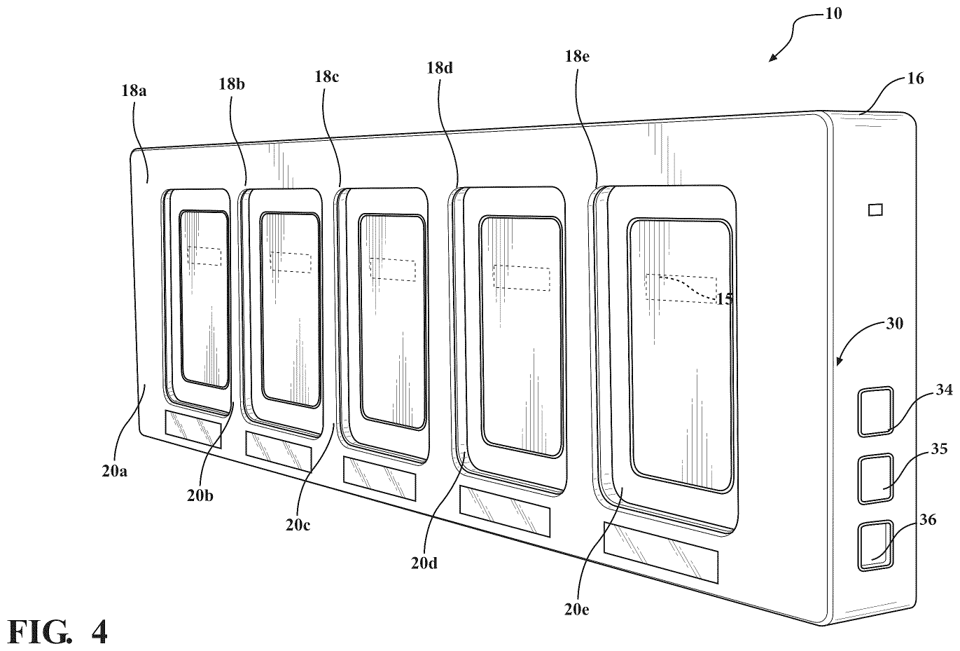

Referring now to FIGS. 1-4, a housing assembly 10 is shown. The housing assembly 10 may be configured to receive a protective display case 12 within a display case cutout 28 formed in a surface of the housing assembly 10. For example, the protective display case 12 may be removably received within the display case cutout 28, such as shown in FIG. 2B. An electromagnetic assembly 22 within the housing assembly 10 adjacent the display case cutout 28 may secure the display case 12 within the display case cutout 28 upon activation. A case light 18 may illuminate a portion of the display case cutout 28. For example, such as shown in FIG. 2A, the case light 18 may surround the display case cutout 28 in order to illuminate the display case 12 held therein. However, as someone of ordinary skill in the art would understand, the case light 18 may be located at any appropriately desired location for illumination of the display case 12 as well as a portion of the display case cutout 28, as desired.

A control device 36, such as shown in FIGS. 1, 2C, and 4 may control activation and deactivation of the electromagnetic assembly 22. The control device 36 may include a push or slide button for controlling an activation and a deactivation of the electromagnetic assembly 22. In certain embodiments, the control device 36 may include a fingerprint scanner. A back light assembly 20 may operate separately or in conjunction with the case light 18 to illuminate an additional portion of or an entirety of the housing assembly 10. A case light switch 34 may be configured to control the case light 18 and the back light assembly 20.

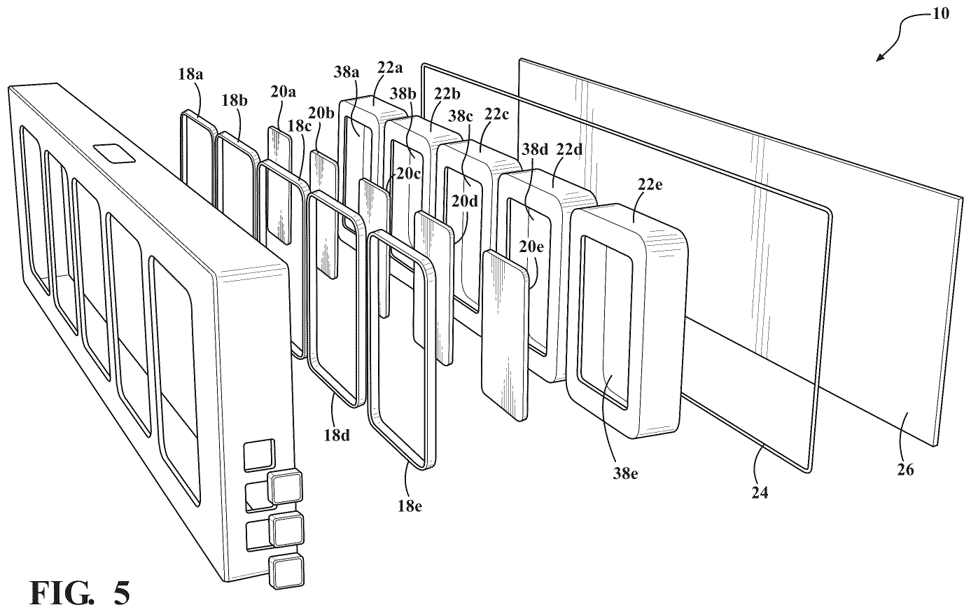

As shown with respect to the embodiment depicted in the exploded view of FIGS. 2 and 5, a back plate 26 may be configured to enclose or attach the electromagnetic assembly 22, the case light 18, and the back light assembly 20. A screen 13 adjacent the display case cutout 28 may display information based on the art or collectable, within the display case 12. For example, an electronic code reader 15 may be configured to read embedded information in the protective display case 12 related to the item within the protective display case 12. The embedded information 122 (FIG. 2C displayed on screen 13) may include one or more various properties or characteristics attributable to the item contained within the protective display case 12, including grade information, production year, brand, card number, and/or authentication detail. The electronic code reader 15 may be configured to read a radio-frequency identification (RFID) tag and/or a near-field communication (NFC) device that is programmed with encapsulation details, grade information, ownership information, and/or other authentication data that can be displayed on the screen 13. The electronic code reader 15 may be configured to read an RFID tag or NFC device located on or embedded in the back of each protective display case 12 or other information of the protective display case 12 to retrieve and display unique details about the item (e.g., card or collectible) on the screen 13. As further shown within FIG. 2A-2C, the screen 13 may be positioned beneath the display case cutout 28. The case light 18 may include LED back lighting configured to create an illuminated display effect behind the protective display case 12 when placed within the display case cutout 28.

As shown within FIGS. 1 and 2C, the housing assembly 10 may be in remote communication, such as through a network 200 with a mobile device 201. The mobile device 201 may be configured to control one or more settings of the case light 18, data visibility on the screen 13, brightness of the screen 13, locking and unlocking of the electromagnetic assembly 22 of the housing assembly 10, as well as other operative features of the housing assembly 10. For example, the mobile device 201 may include a programmable application for controlling the housing assembly 10.

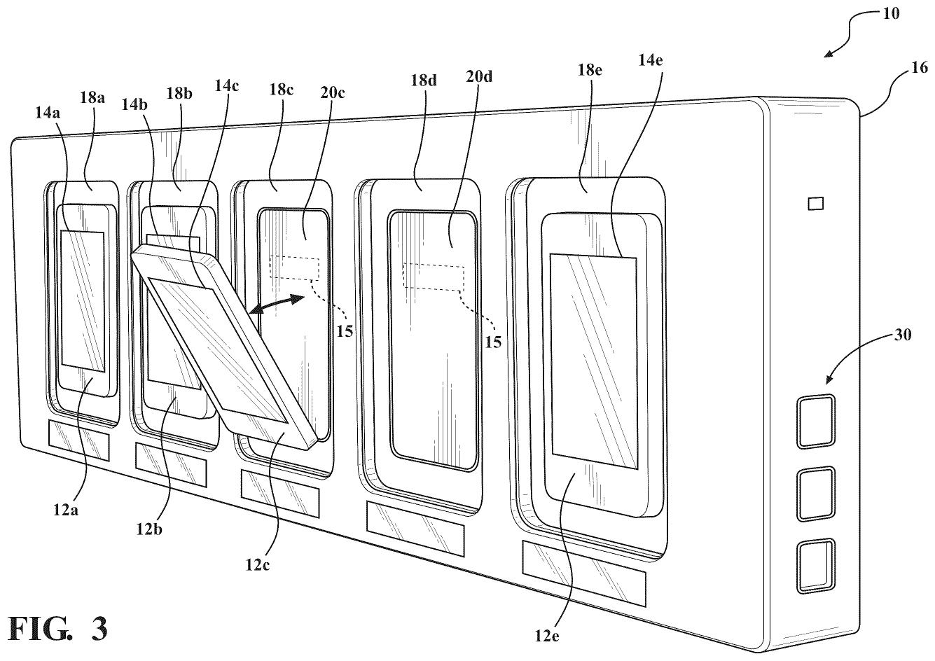

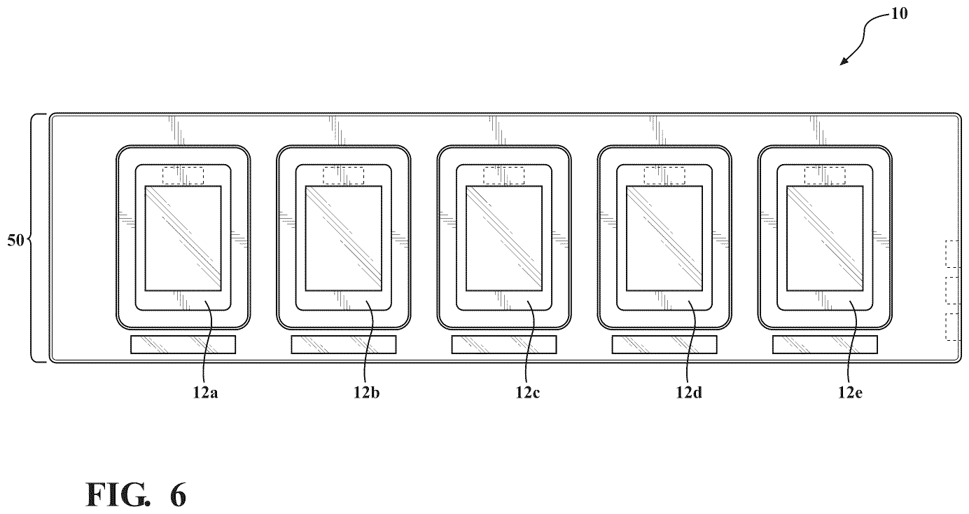

Referring now to the FIGS., the housing assembly 10 may include a plurality of display cutouts 28 (FIGS. 2A and 2B). In particular, the housing assembly 10 may be configured to receive a plurality of protective display cases 12a-12e (FIG. 6), each containing one or more items 14a-14c, and 14e (FIG. 3), such as pieces of art or collectibles. In combination, the housing assembly 10 and the protective display cases 12a-12e may be configured to prevent damage to the items 14a-14e, enhance security, deter counterfeiting, and enhance the visual presentation of the items 14a-14e.

The housing assembly 10 may include a main body 16, a plurality of case lights 18a-18e, a plurality of back light assemblies 20a-20e, a plurality of electromagnetic assemblies 22a-22e, a back light screen 24 and a back plate 26. The main body 16 may be configured as a housing to enclose, in combination with the back plate 26, the plurality of case lights 18a-18e, the plurality of background sheets 20a-20e, the plurality of electromagnetic assemblies 22a-22e, the back light screen 24 and the plurality of protective display cases 12a-12e. The main body 16 may include a plurality of display case cutouts 28a-28e, a case light switch 34 for controlling the case light 18, a back light switch 35 for controlling the back light screen 24, and the control device 36.

As shown in FIGS. 2A and 2B each of the display case cutouts 28 may have a generally rectangular cross-sections shape configured to receive a protective display case 12. As shown in FIG. 3, in an installed arrangement, each of the protective display cases 12a-12c and 12e may be secured against an associated case light 18a-18c and 18e. However, it should be appreciated that each display case cutout 28 may have other appropriately desired shapes for receiving a cooperatively shaped protective display case 12.

The case light switch 34 and the back light switch 35 may control the plurality of case lights 18a-18e. While a case light switch 34 and a back light switch 35 are shown, in other embodiments, more or less than two light switches may be provided. The control device 36 may be configured to enable control of the features of the housing assembly 10 in an embodiment including multiple protective display cases 12. The plurality of case lights 18a-18e may be configured to illuminate portions of an associated display case cutout 28 in a manner such that a backlit glow is formed behind each of the protective display case 12a-12c, and 12e. Each of the plurality of case lights 18a-18e may have any appropriately desired form sufficient to create a backlit glow behind each of the protective display cases 12a-12e.

Each of the plurality of back light assemblies 20a-20e may be configured for placement within a respective cavity 38a-38e (FIG. 5) formed within the plurality of electromagnetic assemblies 22a-22e and may provide an aesthetically pleasing appearance behind the item 14a-14e. It should be appreciated that multiple desired colors and other enhancements may be used. It should also be appreciated that the back light assemblies 20a-20e may include surface features and/or surface ornamentation to further enhance the aesthetically pleasing appearance.

Each of the protective display cases 12a-12e may be configured to encase the item 14 in a protective case that facilitates display of both front and rear sides of the item 14 while protecting the memorabilia from damage, counterfeiting and theft. In certain embodiments, each protective display case 12 may include a front and a rear chassis, a circumferential bezel, front and rear layers of protective glass and a plurality of gaskets and spacers. One or more portions of the front and rear chassis may be formed of ferromagnetic metals, such as the non-limiting examples of iron, cobalt, steel, nickel, manganese, gadolinium, and lodestone.

The protective display cases 12 may be retained within the housing assembly 10 by the electromagnetic assembly 22. One nonlimiting example of a protective display case 12 is described in pending utility patent application Ser. No. 17/897,605, filed on Aug. 29, 2022, and having a title of “Protective Display Case,” which is incorporated herein by reference. However, it should be appreciated that the protective display case 12 may have other forms and may be assembled with other structures, components, and devices.

The electromagnetic assembly 22 may be configured to magnetically attract ferromagnetic metals of an associated protective display case 12 and retain the protective display case 12 within an associated cavity 38. In certain embodiments, the magnetic attraction provided by an electromagnetic assembly 22 is in a range of from about 50 lb/in² to about 150 lb/in². Without being bound by theory, it is believed magnetic forces in this range may be effective in preventing unauthorized removal of the protective display cases 12a-12e from the housing assembly 10. However, in other embodiments, the magnetic attraction provided by each of the of electromagnetic assemblies 22a-22e can be less than about 50 lb/in² or more than about 150 lb/in², sufficient for the functions described herein.

In certain embodiments, the control device 36 may be coupled to the electromagnetic assembly 22 in a manner such that the control device 36 may be used to activate and deactivate the plurality of electromagnetic assemblies 22a-22e. In alternate embodiments, other structures, mechanisms and devices may be used to activate/deactivate the plurality of electromagnetic assemblies 22a-22e.

The back light screen 24 may be configured to illuminate portions of the housing assembly 10 in a manner that a backlit glow is formed behind the housing assembly 10. The back light screen 24 may have any desired form sufficient to form a backlit glow behind each of the housing assembly 10. The back plate 26 may be configured for attachment to the main body 16 in a manner such as to enclose the plurality of case lights 18a-18e, the plurality of back light assemblies 20a-20e, the plurality of electromagnetic assemblies 22a-22e and the back light screen 24. The back light screen 24 may have any appropriately desired form and may be formed from any desired materials sufficient to enclose the plurality of case lights 18a-18e, the plurality of background sheets 20a-20e, the plurality of electromagnetic assemblies 22a-22e and the back light screen 24.

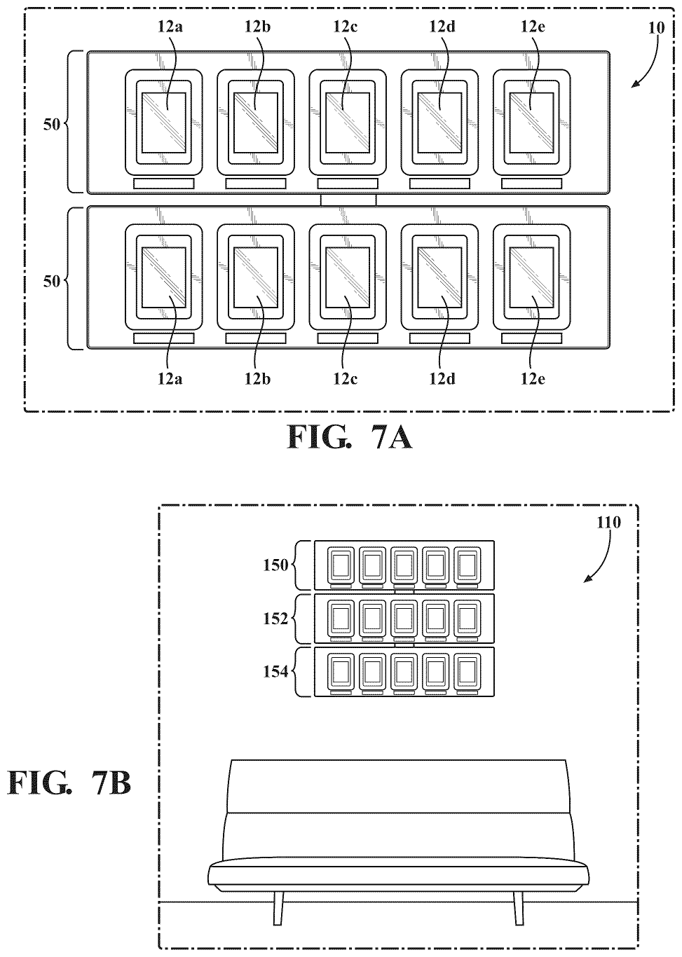

Referring now to FIG. 7A, another embodiment of a housing assembly 10 is shown. A plurality of protective display cases 12a-12e and their respective plurality of electromagnetic assemblies 22a-22e (not shown for purposes of clarity) may be arranged in a single row 50. However, it should be appreciated that in other embodiments, the plurality of protective display cases 12a-12e and the respective plurality of electromagnetic assemblies 22a-22e may be arranged in vertical rows and/or horizontal rows, and other appropriately desired configurations.

Referring now to FIG. 7B, an alternate mounting of housing assemblies 10 is shown generally at 110. A plurality of protective display cases 12a-12e and their respective plurality of electromagnetic assemblies 22a-22e (not shown for purposes of clarity) are arranged in three rows: a first row 150, a second row 152, and a third row 154. However, it should be appreciated that in other embodiments, the plurality of protective display cases 12 and their respective plurality of electromagnetic assemblies 22a-22e may be arranged in more or less than a quantity of three rows.

While the embodiments of the protective display cases 12 and their respective plurality of electromagnetic assemblies 22 shown in FIGS. 7A and 7B illustrate arrangements in aligned rows and columns, it should be appreciated that in other embodiments, the protective display cases 12 and their respective plurality of electromagnetic assemblies 22 can be arranged in other patterns including random arrangements.

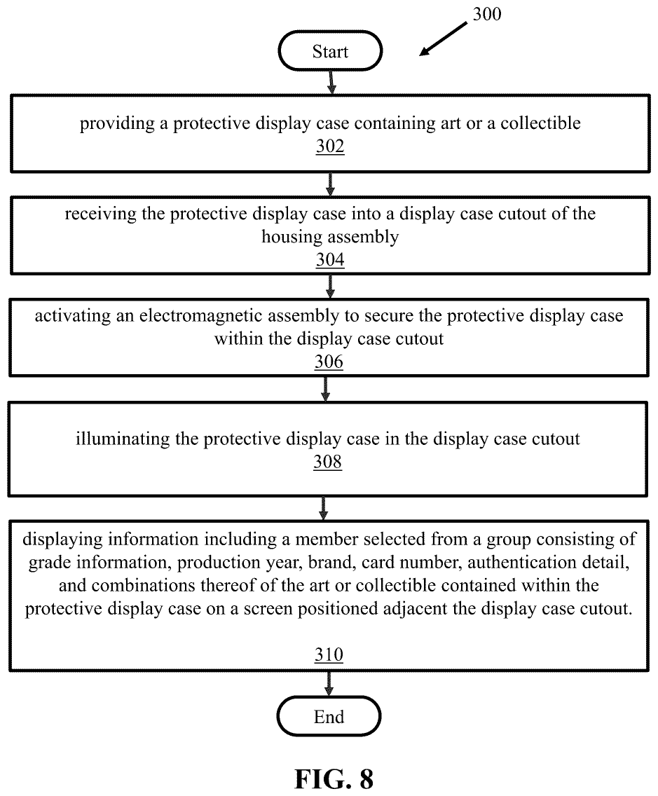

As shown within FIG. 8, a method 300 of using a housing assembly 10 for protecting and displaying art and collectibles, may include a first step 302 of providing a protective display case 12, such as described above. A second step 304 may include receiving the protective display case 12 into a display case cutout 28 of the housing assembly 10. In a third step 306, an electromagnetic assembly 22 may be activated to secure the protective display case 12 within the display case cutout 28 and in a fourth step 308, the illuminating the protective display case 12 may be illuminated in the display case cutout 28. A fifth step 312 may include displaying information including a member selected from a group consisting of grade information, production year, brand, card number, authentication detail, and combinations thereof of the art or collectible contained within the protective display case on a screen positioned adjacent the display case cutout. In certain embodiments, the method may further include removing the protective display case 12 from the display case cutout 28, inserting a different protective display case 12 containing art or a collectible into the display case cutout 28 and updating the screen 13 to display authentication information of the art or collectible contained within the different protective display case 12. As described above, the housing assembly 10 may be controlled using a mobile device 201.

Advantageously, the present technology provides physical protection through electromagnetic locking mechanisms and scanning access controls such as biometric fingerprint scanning to prevent unauthorized access and theft. The housing assembly 10 may integrate one or more electronic readers within each display bay that work with RFID or NFC signals to store ownership, grading, and provenance information, while a screen 13 positioned adjacent and/or beneath each display case cutout show item details including production year, brand, grade, grading company information, card number, and population report data. The system may further include back lighting and case bay lighting controlled through a mobile application interface that manages lighting settings, data visibility on the screen 13, screen brightness adjustments, and electromagnetic locking mechanisms, thus creating a display system that protects collectibles from damage and counterfeiting while maintaining secure tracking of ownership and providing an enhanced presentation that can be customized to showcase each piece

### EXAMPLES

The present technology includes examples demonstrating various implementations and configurations of the housing assembly, as detailed below.

### Example 1: Housing and Mounting Assembly Configuration

The housing and mounting assembly may include a display case cutout having a generally rectangular cross-section formed through the main body for removably receiving a protective display case. The cutout may include an electromagnetic assembly mounted within the main body adjacent to the display case cutout, wherein the electromagnetic assembly is configured to provide magnetic attraction in a range from about 50 lb/in² to about 150 lb/in² to secure the protective display case. A scanning device comprising a fingerprint scanner may control activation and deactivation of the electromagnetic assembly for selectively receiving the display case.

The housing assembly may further incorporate a case light configured to illuminate a portion of the display case cutout and form a backlit glow behind the protective display case. A screen, such as an LCD screen may be positioned beneath the display case cutout and work in conjunction with an electronic reader configured to scan the protective display case. The screen may be configured to display unique details about the art or collectibles contained within the protective display case, including production year, brand, grade, grading company information, card number, parallel/variation status, and population report data

The housing and mounting assembly may be configured in a single row arrangement containing multiple display case cutouts arranged horizontally. Each cutout may include an electromagnetic assembly providing magnetic attraction to secure protective display cases containing trading cards. The housing and mounting assembly may also be arranged in horizontal rows or vertical rows, with protective display cases organized in a grid pattern. Each row may contain multiple display case cutouts equipped with the electromagnetic assembly and individual case bay lighting systems. The rows may be configured to allow modular interconnectivity with other displays through top and bottom ports.

The electronic readers may communicate with a screen positioned adjacent or beneath each cutout to display authentication and provenance information for the items contained within the protective cases. The electromagnetic assemblies secure the protective cases while allowing authorized access through the biometric fingerprint scanner.

A mobile application interface may provide control over the lighting and security features for all rows simultaneously. For example, a user may adjust individual case bay lighting, manage data display settings for each screen, and control the electromagnetic locking mechanisms through the application. The multi-row configuration maintains the same security and authentication features as the single row arrangement while accommodating a larger collection.

### Example 2: Premium Card Display Implementation

The security mounting assembly may be configured to display high-value sports trading cards, including items such as rookie cards of notable athletes, and other collectibles. Each protective display case may contain front and rear chassis formed of ferromagnetic metals, front and rear layers of protective glass, a circumferential bezel, and gaskets and spacers. The cases may be secured within the display cutouts by electromagnetic assemblies while being illuminated by LED back lighting and case bay lighting systems.

The screen adjacent or beneath each display case may show specific information including the card's grade, grading company, card number, and population report statistics. This information may remain visible as long as the case stays in the bay, returning to a blank state when the case is removed and show additional information as the protective case containing the protective display case and collectible is changed.

The mobile application may enable remote management of the display including control of the back lighting intensity, screen brightness, and security settings. A scanner, such as a biometric fingerprint scanner may provide secure access control, allowing only an authorized user to deactivate the electromagnetic assemblies and remove the protective cases.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A housing assembly for a protective display case, comprising:
a display case cutout formed in a surface of the housing assembly and configured for removably receiving the protective display case,
an electromagnetic assembly within the housing assembly adjacent the display case cutout, wherein the electromagnetic assembly is configured to secure the display case within the display case cutout; and
a case light configured to illuminate a portion of the display case cutout.

2. The housing assembly of claim 1, further comprising a control device coupled to the electromagnetic assembly to control activation and deactivation of the electromagnetic assembly.

3. The housing assembly of claim 2, wherein the control device includes a fingerprint scanner.

4. The housing assembly of claim 1, further comprising a back light assembly configured for placement within a cavity of the electromagnetic assembly, the back light assembly configured to operate with the case light to illuminate the housing assembly.

5. The housing assembly of claim 4, further comprising a light switch configured to control the case light and the back light assembly.

6. The housing assembly of claim 5, further comprising a back plate configured to enclose the electromagnetic assembly, the case light, and the back light assembly.

7. The housing assembly of claim 1, further comprising a screen adjacent to the display case cutout.

8. The housing assembly of claim 7, wherein the screen is positioned beneath the display case cutout.

9. The housing assembly of claim 8, further comprising an electronic code reader configured to read embedded information in the protective display case.

10. The housing assembly of claim 9, wherein the information includes a member selected from a group consisting of grade information, production year, brand, card number, authentication detail, and combinations thereof.

11. The housing assembly of claim 9, wherein the screen is configured to display information of an item contained within the protective display case.

12. The housing assembly of claim 1, wherein the case light comprises back lighting configured to create an illuminated display effect behind the protective display case.

13. The housing assembly of claim 1, wherein the display case cutout is comprised by a plurality of display case cutouts.

14. The housing assembly of claim 13, wherein the plurality of display case cutouts is arranged in a vertical row or a horizontal row.

15. The housing assembly of claim 1, wherein the housing assembly is in remote communication with an electronic device.

16. The housing assembly of claim 1, further comprising the protective display case disposed within the display case cutout.

17. A method of using a housing assembly for protecting and displaying an item, the method comprising:
receiving a protective display case containing the item;
inserting the protective display case into a display case cutout of the housing assembly;
activating an electromagnetic assembly to secure the protective display case within the display case cutout;
illuminating the protective display case in the display case cutout; and
displaying information including a member selected from a group consisting of grade information, production year, brand, card number, authentication detail, and combinations thereof of the item contained within the protective display case on a screen positioned adjacent the display case cutout.

18. The method of claim 17, further comprising:
updating the screen to display authentication information of a different received item contained within a different protective display case.

19. The method of claim 17, further comprising controlling the housing assembly using a remotely located device.

20. A housing system for a protective display case comprising:
a plurality of display case cutouts, each display case cutout formed in a surface of the housing system and configured for removably receiving a protective display case, each display case cutout including an electromagnetic assembly and a case light, the electromagnetic assembly within the housing assembly adjacent the display case cutout, the electromagnetic assembly configured to secure the display case within the display case cutout, and the case light configured to illuminate a portion of the display case cutout;
a scanning device configured to enable control of the electromagnetic assembly;
a plurality of screens, each screen positioned beneath one of the display case cutouts;
a plurality of electronic code readers, each reader in a respective display space cutout, each reader configured to read information from the respective protective display case and retrieve a detail about an item contained within the respective protective display case, wherein the detail is displayed on the respective screen; and
an electronic device in remote communication with the housing system and configured to control a member selected from a group consisting of: a lighting setting, data visibility on the screen, screen brightness, locking and unlocking of the electromagnetic assemblies of the housing system, and combinations thereof.
